(19) United States
(12) Patent Application Publication
(10) Pub. No.: US 2006/0199049 A1
(43) Pub. Date: Sep. 7, 2006

(54) Monitoring system for fuel cell stack

(75) Inventors: Liqing Hu, Shanghai (CN); Mingzhu Fu, Shanghai (CN)

Correspondence Address: Raymond Y. Chan, 108 N. Ynez Ave., #128, Monterey Park, CA, 91754, US

(73) Assignee: Shen-Li High Tech Co., Ltd. (Shanghai)

(21) Appl. No.: 11/073,196

(22) Filed: Mar. 4, 2005

(51) Int. Cl. H01M 8/00; H01M 8/04

(52) U.S. Cl. 429/13; 429/22

(57) ABSTRACT

A monitoring system includes a plurality of monitoring sensors for electrically connecting to fuel cell units of a fuel cell stack respectively, wherein a voltage of each of the fuel cell units is measured when two corresponding neighboring monitoring sensors are switched on. An alert controller includes a switch control sequentially switching each two neighboring monitoring sensors, and an alert device arranged when the voltage of the respective fuel cell unit is within a safety range, the switch control continuously switches on another two neighboring monitoring sensors until the voltage of the last fuel cell unit is read, and when the voltage of the respective fuel cell unit is out of the safety range, the alert device generates an alert signal for indicating an abnormal operation of the respective fuel cell unit of the fuel cell stack.

### BACKGROUND OF THE PRESENT INVENTION

1. Field of Invention

The present invention relates to fuel cells, and more particularly to a monitoring system for a fuel cell stack for monitoring the output voltage of each cell unit of the fuel cell stack so as to ensure the fuel cell stack working under an optimum condition.

2. Description of Related Arts

Electrochemical fuel cell is a kind of electrochemical energy conversion device which is capable of converting the hydrogen and oxidant into electrical energy. The core part of this device is a membrane electrode assembly (MEA). The MEA comprises a proton exchange membrane sandwiched by two porous sheets made of conductive material such as carbon tissue. Catalyst like metal platinum powder, adapted for facilitating the electrochemical reaction, are evenly and granularly provided on two layers of carbon tissue to form two catalytic interfaces between MEA and carbon tissue. Furthermore, electrically conductible members are provided on two sides of MEA to form a cathode and an anode, in such a manner, electrons generated from the electrochemical reaction are capable of being lead out through an electrical circuit.

The anode of the MEA is supplied with fuel, such as hydrogen, for initiating the electrochemical reaction. The fuel is forced through the porous and diffused carbon tissue, and is capable of being deionized on the catalytic interface for the loss of electrons to generate positive ions. Moreover, positive ions are capable of transferably penetrating the proton exchange membrane to reach the cathode. On the other hand, an oxidant-containing gas, such as air, is supplied to the cathode of the MEA. Accordingly, the oxidant-containing gas is able to penetrate the porous and diffused carbon tissue to be ionized for the addition of the electrons to generate negative ions. Finally, the positive ions transferred from the anode will meet the negative ions to form reaction product.

In the electrochemical fuel cells which employ the hydrogen as the fuel and oxygen containing air as the oxidant, the electrochemical reaction on the anode generates hydrogen positive ions (protons). The proton exchange membrane is capable of facilitating the hydrogen positive ions migrate from the anode to the cathode. In addition, the proton exchange member has another function as a separator for blocking hydrogen containing air flow from being directly contacted with the oxygen containing air flow so as to prevent the mixture of hydrogen and oxygen as well as the explosive reaction.

The electrochemical reaction on the cathode side of fuel cell generates negative ions by obtaining the electrons. As a result, the negative ions generated on the cathode side will attract the positive ions transferred from the anode side to form water molecule as reaction product. In the electrochemical fuel cells which utilized the hydrogen as the fuel and oxygen containing air as oxidant, the electrochemical reaction is expressed by the following formula:
Anode: H₂→2H⁺+2e
Cathode: ½O₂+2H⁺+2e→H₂O

In the typical proton exchanging membrane fuel cell system, the MEA is disposed between two electrically conductible electrode plates wherein the contacting interface of each electrode plate at least defines one flowing channel. The flowing channel could be embodied by conventional mechanical method such as pressure casting, punching, and mechanical milling. The electrode plate could be embodied as metal electrode plate or graphite electrode plate. So the flowing channels defined on the electrode plate are capable of directing fuel and oxidant into anode side and cathode side respectively positioned on opposite side of the MEA. For a single fuel cell structure, only one MEA is provided and disposed between an anode plate and a cathode plate. Here, the anode plate and the cathode plate not only are embodied as current-collecting device, but also as a supporting device for securely holding the MEA. The flowing channels defined on the electrode plate are capable of delivering fuel and oxidant to the catalytic interfaces of the anode and cathode, and removing the water discharged from the electrochemical reaction of fuel cell.

To increase the overall power output of the proton exchanging membrane fuel cell, two or more fuel cells are electrically connected in series with a stacked manner or a successive manner to form a fuel cell stack. In such stacked series manner, each electrode plate comprises flowing channels defined on opposite side of plate respectively wherein one side of the electrode plate is applied as an anode plate contacting with the anode interface of a MEA, while another side of the electrode plate is applied as a cathode plate contacting with the cathode interface of an adjacent MEA. That is to say, one side of such electrode plate serve as an anode plate for one cell body and the other side of plate serve as a cathode plate for the adjacent cell. Within the art, this kind of structure is called bipolar plate.

It has been practiced in the art to use such fuel cell systems as power unit for propelling vehicles including four-wheeled motor vehicles and motorcycles and for operating other electrically operated machines such as portable generators.

Since the proton exchange membrane fuel cell stack is combined by electrically connecting a plurality of individual fuel cells in series or in parallel manner, a monitoring system for monitoring the voltage output of each single fuel cell is very important. This is due to the fact that the monitoring system could prevent any abnormal operation, such as overcurrent or excess working temperature of the fuel cell stack.

Accordingly, the overall output voltage of the fuel cell stack is determined by the accumulation of the outputs of the individual fuel cells electrically connected in a series manner. Therefore, once one of the individual fuel cells fails to operate, the overall performance of the fuel cell stack would be downgraded. In other words, it is crucial to monitor the performance of individual cell to ensure the overall performance of the fuel cell stack in good shape. Especially, when an electrode was disruptive, the voltage output of such electrode would reach an abnormal value, such as a value close to zero, even to a negative value. In contrary, the voltage output value of a normal fuel cell unit should be within a range between 0.5-1.2V.

Referring to the FIG. 1, the conventional monitoring device comprises a plurality of measuring lines connecting to the individual fuel cells of the fuel cell stack respectively, wherein each of the measuring lines is electrically connected to a circuit board of a differential amplifier such that a voltage signal is sent out from each of the measuring lines to a signal processing unit through the corresponding circuit board for monitoring the voltage output of each of the individual fuel cells.

However, such monitoring device suffers some unavoidable drawbacks. First of all, when a relatively large numbers of individual fuel cells are operated, the voltage potential between the first measuring line at the first individual fuel cell and the last measuring line at the last individual fuel cell will be rather high. As a result, the circuit board and the signal processing unit incorporated with the fuel cell stack must be designed to withstand a higher voltage. Therefore, this special configuration will lead the cost and complexity of the circuit board while the differential amplifying process could be inaccurate as the number of individual fuel cell increases. Secondly, such monitoring device requires a plurality of circuit boards, which are bulky and complicated to be interconnected.

### SUMMARY OF THE PRESENT INVENTION

A main object of the present invention is to provide a monitoring system for a fuel cell stack, wherein the monitoring system is capable of directly measuring the voltage output of each fuel cell unit and instantly diagnosing and alerting an abnormal operational condition of the fuel cell stack.

Another object of the present invention is to provide a monitoring system for a fuel cell stack, wherein the diagnosis of the fuel cell stack is accurate because the monitoring system measures the voltage output of each of the fuel cell units through the control switch.

Another object of the present invention is to provide a monitoring method for accurately and rapidly diagnosing a fuel cell stack so as to ensure the fuel cell stack operating under optimum condition.

Accordingly, in order to accomplish the above object, the present invention provides a monitoring system for a fuel cell stack having a plurality of fuel cell units, comprising:

a monitor device comprising a plurality of monitoring sensors adapted for electrically connecting to the fuel cell units of the fuel cell stack respectively, wherein the monitor device is adapted for measuring a voltage of each of the fuel cell units when two corresponding neighboring monitoring sensors are switched on; and

an alert controller, which is electrically connected to the monitor device, comprising a switch control sequentially switching each two neighboring monitoring sensors for reading the voltage of the respective fuel cell unit, and an alert device arranged in such a manner that when the voltage of the respective fuel cell unit falls within a safety range, the switch control continuously switches on another two neighboring monitoring sensors for reading the voltage of the subsequent fuel cell unit until the voltage of the last fuel cell unit is read, and when the voltage of the respective fuel cell unit is out of said safety range, the alert device generates an alert signal for indicating an abnormal operation of the respective fuel cell unit of the fuel cell stack.

The present invention further provides a method of monitoring the fuel cell stack having a plurality of fuel cell units, comprising the steps of:

(a) communicatively connecting a plurality of monitoring sensors to the fuel cell units of the fuel cell stack respectively,

(b) sequentially switching each two neighboring monitoring sensors for reading an voltage of the respective fuel cell unit so as to collect the voltage of the fuel cell units;

(c) diagnosing the voltage of the fuel cell units, wherein when the voltage of the respective fuel cell unit falls within a safety range, another two neighboring monitoring sensors are continuously switched on for reading the voltage of the subsequent fuel cell unit until the voltage of the last fuel cell unit is read; and

(d) generating an alert signal for indicating an abnormal operation of the respective fuel cell unit of the fuel cell stack when the voltage of the respective fuel cell unit is out of the safety level.

These and other objectives, features, and advantages of the present invention will become apparent from the following detailed description, the accompanying drawings, and the appended claims.

### BRIEF DESCRIPTION OF THE DRAWINGS

FIG. 1 is a conventional monitoring system for a fuel cell stack.

FIG. 2 is a schematic view of a monitoring system for a fuel cell stack according to a preferred embodiment of the present invention.

FIGS. 3A and 3B are circuit diagrams of the monitoring system according to the above preferred embodiment of the present invention.

FIGS. 4 and 4A to 4H are circuit diagrams of an A/D converter of the monitoring system according to the above preferred embodiment of the present invention.

FIG. 5 is a flow chart of a method of monitoring an output voltage of fuel cell units of a fuel cell stack according to the above preferred embodiment of the present invention.

FIG. 6 is a block diagram of the monitoring system according to the above preferred embodiment of the present invention.

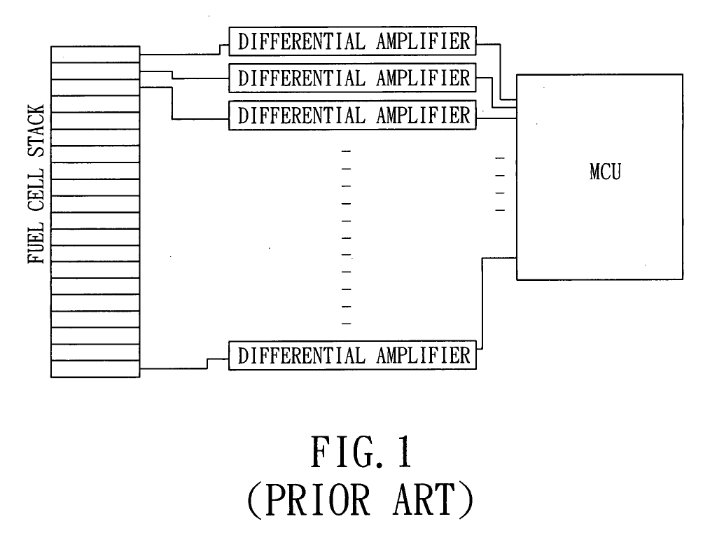

### DETAILED DESCRIPTION OF THE PREFERRED EMBODIMENT

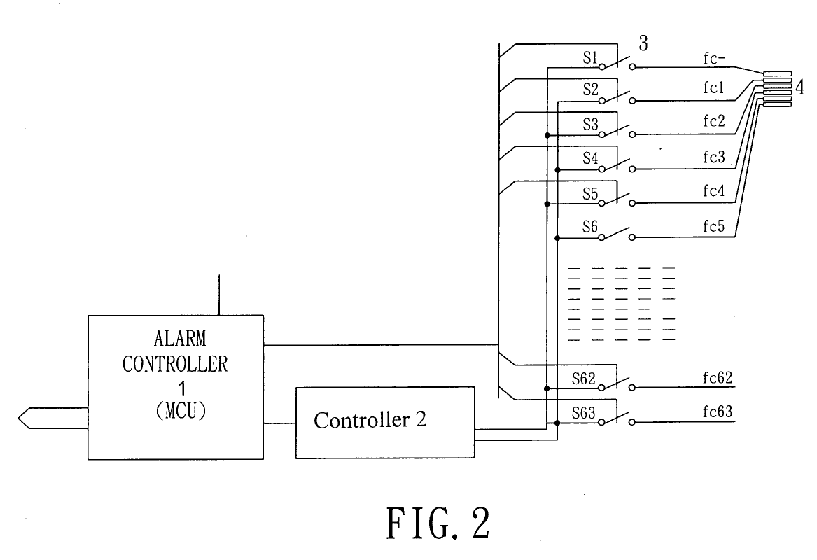

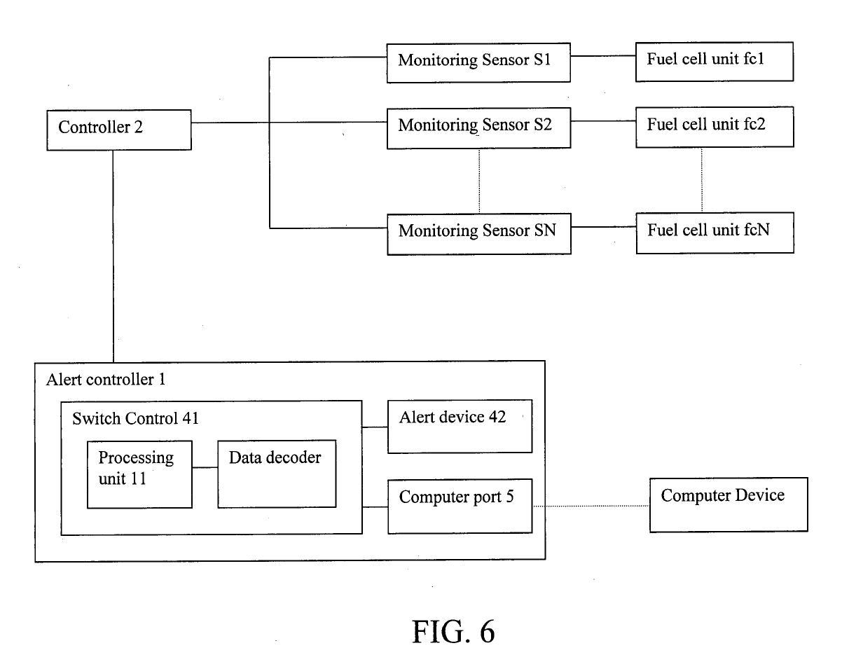

Referring to FIGS. 2 and 6 of the drawings, a monitoring system for monitoring an output voltage of a fuel cell stack 4 having a plurality of fuel cell units (fc1, fc2 . . . ) is illustrated, wherein each of the fuel cell units (fc1, fc2 . . . ) comprises at least an individual fuel cell such that the monitoring system is adapted to monitor the voltage of each individual fuel cell when each fuel cell unit (fc1, fc2 . . . ) contains one single fuel cell or the voltage of fuel cells when each fuel cell unit (fc1, fc2 . . . ) contains two or more fuel cells as a group.

The monitoring system comprises a monitor device 3, a controller 2, and an alert controller 1.

The monitor device 3 comprises a plurality of monitoring sensors (S1, S2 . . . ) adapted for electrically connecting to the fuel cell units (fc1, fc2 . . . ) of the fuel cell stack 4 respectively, wherein the monitor device 3 is adapted for measuring the voltage of each of fuel cell units (fc1, fc2 . . . ) when two corresponding neighboring monitoring sensors (S1, S2 . . . ) are switched on.

The controller 2 is electrically connected to the monitoring switches (S1, S2 . . . ) of the monitor device 3 for converting the voltage of each of the fuel cell units (fc1, fc2 . . . ) into a digital signal. Preferably, the controller 2 comprises an A/D converter, a noise filter and an amplifier for facilitating the voltage signal reading process. It is worth to mention that by equipping the noise filter into the controller 2, the error tolerance property of the controller 2 could be significantly improved for enhancing the overall operating efficiency and accuracy.

The alert controller 1, which is electrically connected to the controller 2, comprises a switch control 41 sequentially switching each two neighboring monitoring sensors (S1, S2 . . . ) for reading the voltage of the respective fuel cell unit (fc1, fc2 . . . ), and an alert device 42 arranged in such a manner that when the voltage of the respective fuel cell unit (fc1, fc2 . . . ) falls within a safety range, the switch control 41 continuously switches on another two neighboring monitoring sensors (S1, S2 . . . ) for reading the voltage of the subsequent fuel cell unit (fc1, fc2 . . . ) until the voltage of the last fuel cell unit (fc1, fc2 . . . ) is read, and when the voltage of the respective fuel cell unit (fc1, fc2 . . . ) is out of the safety range, the alert device 42 generates an alert signal for indicating an abnormal operation of the respective fuel cell unit (fc1, fc2 . . . ) of the fuel cell stack 4.

Here, the safety range refers to a voltage output value of a normal fuel cell unit, which is commonly ranging from 0.5-1.2V. That is to say, in case once of fuel cell unit is out of order, the output voltage collected by two neighboring monitoring sensor would be lower than 0.5 V, as a result, the alter device 42 would indicate an alert signal.

According to the preferred embodiment, the fuel cell stack 4 comprises 63 fuel cell units (fc1˜fc63), wherein 63 monitoring sensors (S1˜S63) are electrically connected to the fuel cell units (fc1˜fc63) respectively. In other words, the first two neighboring monitoring sensors S1, S2 are corresponding switched on by the switch control 41 in order to collect the voltage of the first fuel cell unit fc1. Likewise, another two neighboring monitoring sensors S2, S3 are corresponding switched on by the switch control 41 in order to collect the voltage of the second fuel cell unit fc2 such that the voltages from the first fuel cell unit fc1 to the last fuel cell unit fc63 are sequentially collected by controller 2 through the monitor device 3 as a diagnosing loop thereof. It is worth to mention that the switch control 41 programmably activates the monitoring sensors (S1˜S63) in an on and off manner that the preceding monitoring sensor (S1˜S63) will be automatically switched off by the switch control 41 when the subsequent monitoring sensor (S1˜S63) is switched on such that only two monitoring sensors (S1˜S63) are switched on at the same time for reading the voltage of the respective fuel cell unit (fc1˜fc63).

Accordingly, the diagnosing loop of the monitor device 3 can be set to repeatedly perform for a predetermined time period to periodically check up whether the fuel cell stack 4 is operating under normal condition. Accordingly, the monitoring sensors S1˜S63 are photoelectric isolating relays that the monitoring sensors S1˜S63 has no direct relay contact to the fuel cell units (fc1˜fc63) and is able to accurately, stably and rapidly measure the output voltages of the fuel cell units (fc1˜fc63) while being cost effective.

According to the preferred embodiment of the present invention, the controller 2 is embodied as an Analog to Digital converter adapted to collect and convert the voltage from each of the fuel cell units (fc1˜fc63) in an analog form into a digital form for further processing in the alert controller 1.

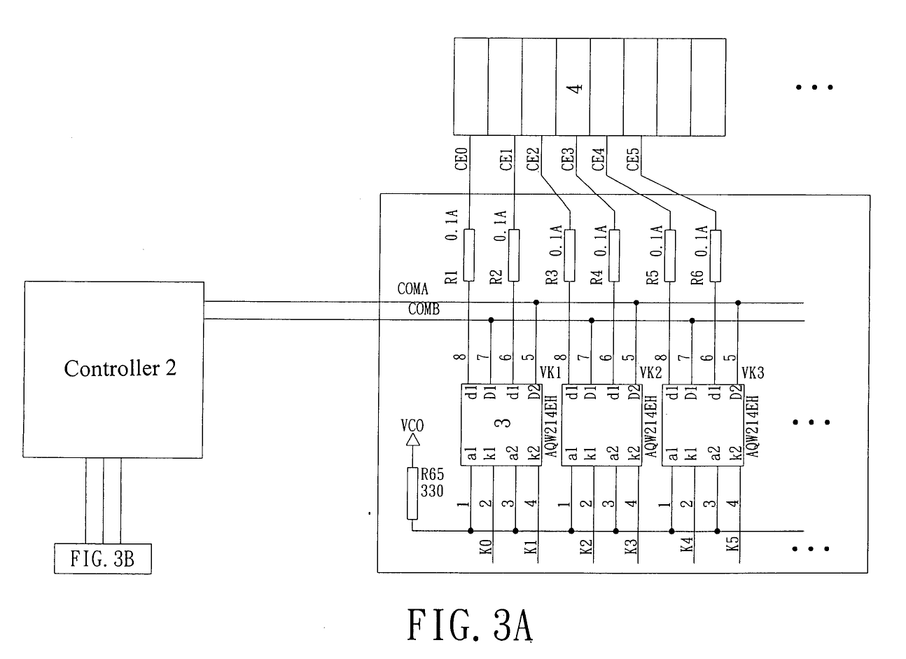

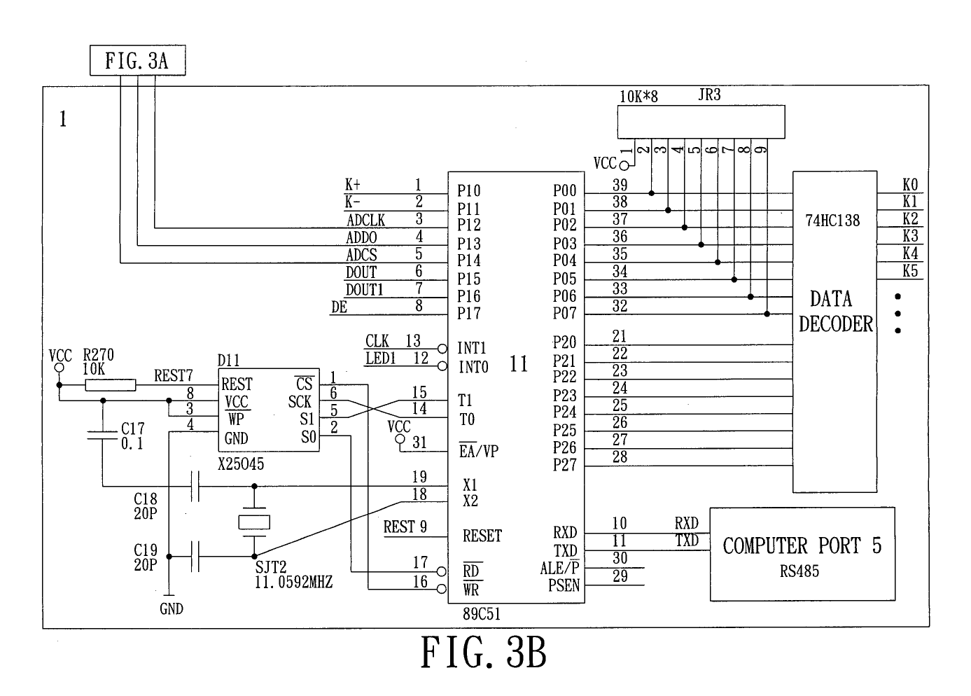

FIGS. 3A and 3B are the circuit diagrams of monitoring system of the present invention. According to the preferred embodiment of the present invention, the monitor device 3 comprises 32 double-unit photoelectric relays (VK1, VK2, . . . . VK32) as the monitoring sensors, wherein each of which comprises two illuminating tubes and two photo cells driver MOSFETs (Metal-Oxide-Semiconductor Field Effect Tube). It is worth to mention that when such kind of photoelectric relays are electrically connected, a very low electric resistance is detected that the resistance value is around tens of ohms which could be ignored under a lower current circumstance. Further, if the illuminating tube is supplied with a 10 mA current, the FET could be conducted. For instance, when the input terminals K0 and K1 of the double unit photoelectric relay VK1 are supplied with low level, D1d1 and D2d2 will be conducted. Therefore, the CE0 will be connected with COMB and CE1 will be connected with COMA. It is worth to mention that CE0 and CE1 respectively connected with two electrodes of the first fuel cell unit. The voltage potential between the CE0 and CE1 obtained by the A/D converter 2 is the voltage potential between two electrodes of the first fuel cell unit.

While the K1 and K2 are supplied with low level, and the K0, K3, and K4 are supplied with high level, the voltage between CE2 and CE1 would be collected by the controller 2. Therefore, the voltage between two electrodes of the second fuel cell unit will be collected. Accordingly, the rest collection will be deduced by this analogy until the voltage of the last fuel cell unit to be collected so as to accomplish the diagnosing loop for the fuel cell stack.

It is noted that during the whole collecting process, only two neighboring (adjacent) photoelectric relays are kept conductible while the remaining photoelectric relays are switched off for guaranteeing a stable operation. Otherwise, the voltage collected by the controller 2 would be rather high thus causing the circuit being ruined or the electrodes being short-circuit. Hence, only two input terminals of photoelectric relay are maintained with low level.

According to the preferred embodiment, the switch control of the alert controller 1 is embodied as a multi-controller unit (MCU) for sending the digital control signal to the monitoring device 3 so as to control the on-off action of each of the monitoring sensors (S1, S2 . . . ). Accordingly, the switch control comprises a processing unit 11 and a data decoder decoding data from the controller 2. The processing unit 11 comprises a memory chip ATMEL89C52 to store necessary software therein. The data decoder comprises eight 3-8/line decoders and a 2 2-4/line decoder 12 which employs a decoding chip 74hc139.

As mentioned before, the MCU of the switch control 41 is adapted for sending a signal to control the on-off action of each photoelectric relay. The MCU of the switch control 41 comprises a processing unit 11 and a data decoder, wherein the processing unit 11 is formed by storing software on an ATMEL89C52 chip; the code translator includes eight 3-8/line decoders and a 2 2-4/line decoder 12 which employs a 74hc139 chip. The eight 3-8/line decoders respectively control four decoders 13 at the even numbered input terminal of bi-unit photoelectric relay and four decoders 14 at the odd numbered input terminal of bi-unit photoelectric relay. It is noted that the decoders 13 and 14 are embodied as 74hc138 chips. It is noted that the MCU of the switch control 41 enables the screening process efficient and prompted.

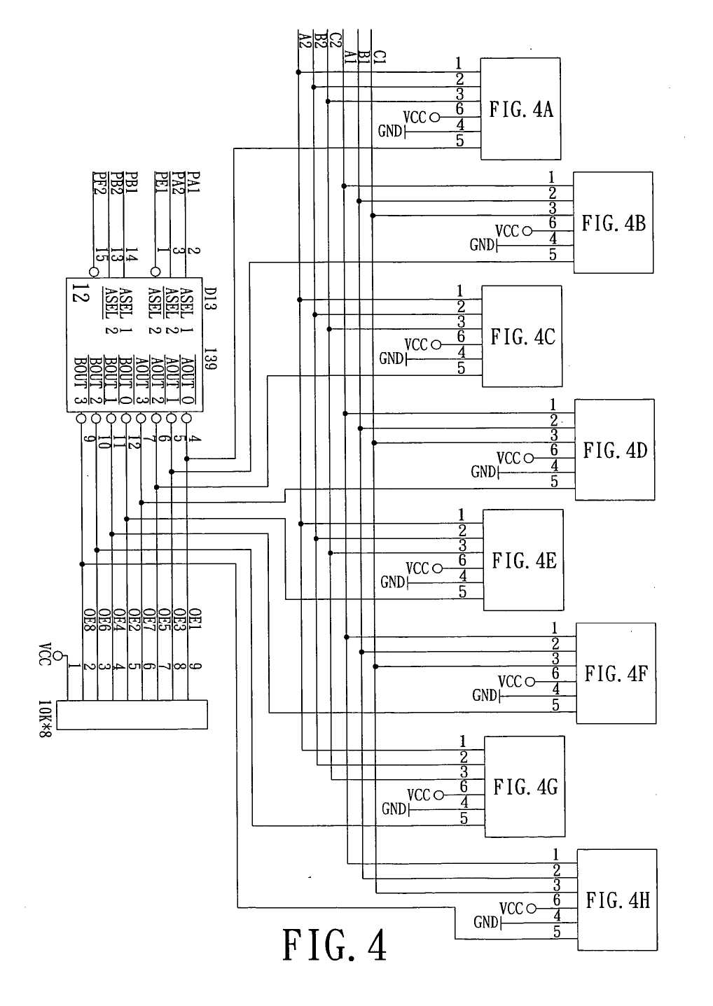

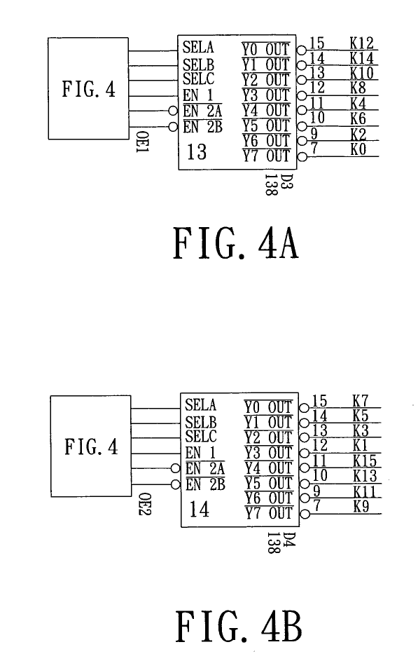

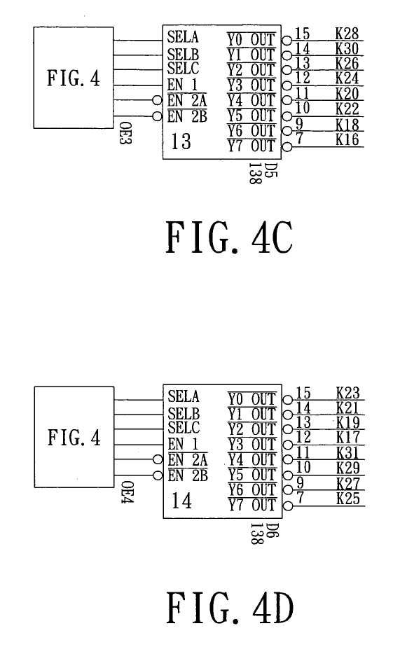

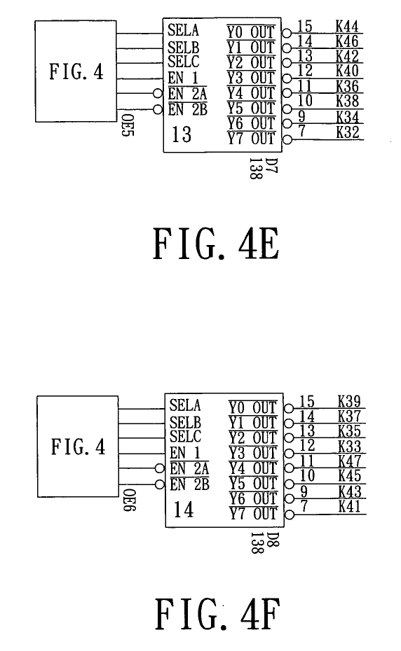

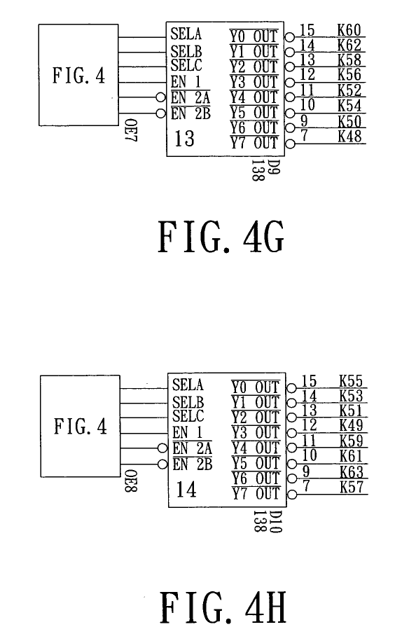

As shown in FIGS. 4 and 4A to 4H, three output terminals P00, P01, and P02 are respectively connected with the input terminals of four decoder 13, while the output terminals of decoders 13 are respectively connected with odd numbered input terminals of bi-unit photoelectric relay, namely K0, K2, K4, K62, wherein the other three output terminals of the processing unit 11, namely P04, P05, and P06 are respectively connected with the input terminals of the other four decoders 14, wherein the output terminals of these four decoders 14 are adapted for respectively controlling the odd numbered input control terminals of bi-unit photoelectric relays, namely, K1, K3, K5, . . . K63.

The output terminals of the processing unit 11, namely P20, P21, P22, P25, P26, P27 are respectively connected with the input end of decoder 12, wherein eight output ends of the decoder 12 are respectively connected to the above mentioned eight 3-8 line decoders, therefore, the code signaled from the processing unit 11 is capable of controlling the outputting signals of such eight 3-8 line decoders so as to ensure that only one even numbered low level and a odd numbered low level are connected with the controlling terminals of the photoelectrical relay. That is to say, at anytime, only two predetermined adjacent photoelectrical relays are switched on. For instance, if the first fuel cell is being checked, only K1 and K2 are maintained with low level, the remaining controlling terminals are kept with high level.

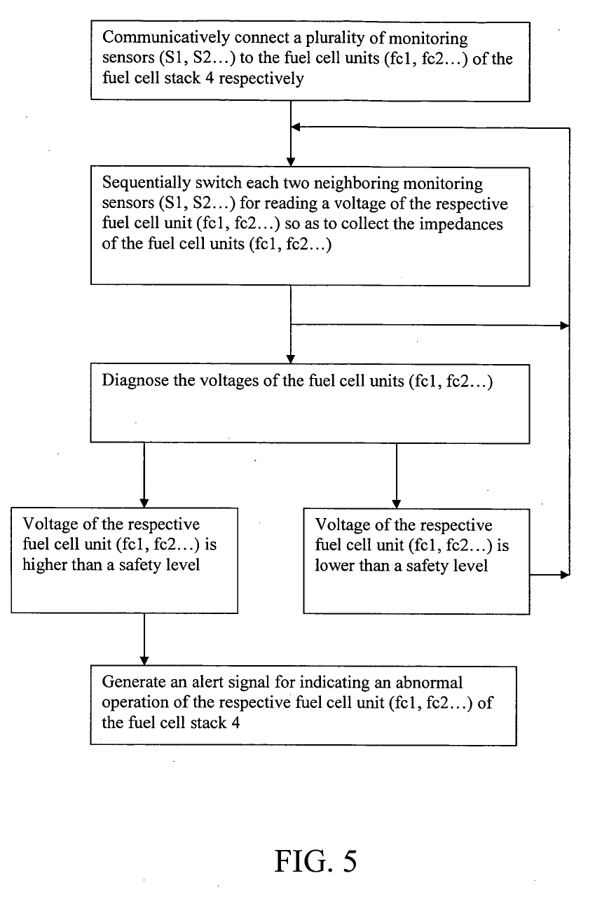

Referring to the FIG. 5, a method for monitoring the output voltage of the fuel cell stack according to the preferred embodiment of the present invention is illustrated. The method comprises the following steps.

(1) Communicatively connect a plurality of monitoring sensors (S1, S2 . . . ) to the fuel cell units (fc1, fc2 . . . ) of the fuel cell stack 4 respectively.

(2) Sequentially switch each two neighboring monitoring sensors (S1, S2 . . . ) for reading an voltage of the respective fuel cell unit (fc1, fc2 . . . ) so as to collect the voltages of the fuel cell units (fc1, fc2 . . . ).

(3) Diagnose the voltages of the fuel cell units (fc1, fc2 . . . ), wherein when the voltage of the respective fuel cell unit (fc1, fc2 . . . ) falls within a safety range, another two neighboring monitoring sensors (S1, S2 . . . ) are continuously switched on for reading the voltage of the subsequent fuel cell unit (fc1, fc2 . . . ) until the voltage of the last fuel cell unit (fc1, fc2 . . . ) is read.

(4) Generate an alarm signal for indicating an abnormal operation of the respective fuel cell unit (fc1, fc2 . . . ) of the fuel cell stack 4 when the voltage of the respective fuel cell unit (fc1, fc2 . . . ) is out of the safety range.

Accordingly, before the step (1), the monitoring system must initialize the fuel cell stack 4 in a normally operating condition. In other words, the monitoring system assumes the fuel cell stack 4 is working properly before diagnosing the fuel cell stack 4 while the monitoring system is set to monitor the fuel cell stack 4 periodically.

In addition, in step (3), further comprises a sub-step of converting the voltages of the fuel cell units (fc1, fc2 . . . ) into digital forms. It is worth to mention that in step (3), when the voltage of the respective fuel cell unit (fc1, fc2 . . . ) is within a safety range, another two neighboring monitoring sensors (S1, S2 . . . ) are then switched for reading the voltage of the subsequent fuel cell unit (fc1, fc2 . . . ). In other words, in step (4), when the voltage of the respective fuel cell unit (fc1, fc2 . . . ) is out of the safety range, the switch control 41 will deactivate the monitoring sensors (S1, S2 . . . ) to stop reading the voltage of the next fuel cell unit (fc1, fc2 . . . ), wherein the alert signal will indicate the abnormal operation of the respective fuel cell unit (fc1, fc2 . . . ). Therefore the respective fuel cell unit (fc1, fc2 . . . ) under the abnormal operation can be found.

Alternatively, when the voltage of the respective fuel cell unit (fc1, fc2 . . . ) is within the safety range, the monitoring sensors (S1, S2 . . . ) will keep reading the voltage of the next fuel cell unit (fc1, fc2 . . . ) until all the voltages of the fuel cell unit (fc1, fc2 . . . ) are read, wherein the alert signal will indicate the abnormal operation of the respective fuel cell unit (fc1, fc2 . . . ). Therefore the respective fuel cell unit (fc1, fc2 . . . ) under the abnormal operation can be found.

As shown in FIG. 3, the monitoring system further has a computer port 5, which is a RS485 port, electrically extended from the alert controller 1 for communicatively connecting to a computer device such that the voltages of the fuel cell unit (fc1, fc2 . . . ) are programmably monitored and recorded by the computer device, so as to ensure the fuel cell stack 4 working under optimum condition. In other words, the computer device is able to hook up to the monitoring system of the system that the safety level of the voltage can be selectively adjusted by the computer device between 1.2˜0.1V. It is worth to mention that the monitoring system takes less than two seconds to complete the diagnosing loop for the fuel cell stack 4 having 63 fuel cell units. The maximum testing voltages are ±4.64V & ±2.32V, and the accuracy tolerance of the monitoring system is ±0.5%.

One skilled in the art will understand that the embodiment of the present invention as shown in the drawings and described above is exemplary only and not intended to be limiting.

It will thus be seen that the objects of the present invention have been fully and effectively accomplished. It embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A monitoring system for a fuel cell stack having a plurality of fuel cell units, comprising:
a monitor device comprising a plurality of monitoring sensors adapted for electrically connecting to said fuel cell units of said fuel cell stack respectively, wherein said monitor device is adapted for measuring an voltage of each of said fuel cell units when said two corresponding neighboring monitoring switches are switched on; and
an alert controller, which is electrically connected to said monitor device, comprising a switch control sequentially switching each said two neighboring monitoring sensors for reading said output voltage of said respective fuel cell unit, and an alert device arranged in such a manner that when said voltage of said respective fuel cell unit falls within a safety range, said switch control continuously switches on another two neighboring monitoring sensors for reading said voltage of said subsequent fuel cell unit until said voltage of said last fuel cell unit is read, and when said voltage of said respective fuel cell unit is out of said safety range, said alert device generates an alert signal for indicating an abnormal operation of said respective fuel cell unit of said fuel cell stack.

2. The monitoring system, as recited in claim 1, further comprising a controller electrically connected to said monitoring sensors of said monitor device for converting said voltage of each of said fuel cell units into a digital signal.

3. The monitoring system, as recited in claim 1, wherein said switch control programmably activates said monitoring sensors in an on and off manner that said preceding monitoring sensor is automatically switched off by said switch control when said subsequent monitoring sensor is switched on such that only said two neighboring monitoring sensors are switched on at said same time for reading said voltage of said respective fuel cell unit.

4. The monitoring system, as recited in claim 2, wherein said switch control programmably activates said monitoring sensors in an on and off manner that said preceding monitoring sensor is automatically switched off by said switch control when said subsequent monitoring sensor is switched on such that only said two neighboring monitoring sensors are switched on at said same time for reading said voltage of said respective fuel cell unit.

5. The monitoring system, as recited in claim 1, wherein said monitoring sensors are photoelectric isolating relays for reading said output voltages of said fuel cell units.

6. The monitoring system, as recited in claim 4, wherein said monitoring sensors are photoelectric isolating relays for reading said output voltages of said fuel cell units.

7. The monitoring system, as recited in claim 1, wherein said switch control is a multi-controller unit (MCU) sending a digital control signal to said monitoring device so as to control an on-off action of each of said monitoring sensors.

8. The monitoring system, as recited in claim 4, wherein said switch control is a multi-controller unit (MCU) sending a digital control signal to said monitoring device so as to control an on-off action of each of said monitoring sensors.

9. The monitoring system, as recited in claim 6, wherein said switch control is a multi-controller unit (MCU) sending a digital control signal to said monitoring device so as to control an on-off action of each of said monitoring sensors.

10. The monitoring system, as recited in claim 1, further having a computer port electrically extended from said alert controller for communicatively connecting to a computer device so as to programmably control said monitoring sensors and to selectively adjust said safety level with respect to said voltage of said fuel cell stack.

11. The monitoring system, as recited in claim 6, further having a computer port electrically extended from said alert controller for communicatively connecting to a computer device so as to programmably control said monitoring sensors and to selectively adjust said safety level with respect to said voltage of said fuel cell stack.

12. The monitoring system, as recited in claim 9, further having a computer port electrically extended from said alert controller for communicatively connecting to a computer device so as to programmably control said monitoring sensors and to selectively adjust said safety level with respect to said voltage of said fuel cell stack.

13. A method of monitoring a fuel cell stack having a plurality of fuel cell units, comprising said steps of:
(a) communicatively connecting a plurality of monitoring sensors to said fuel cell units of said fuel cell stack respectively,
(b) sequentially switching each said two neighboring monitoring sensors for reading an voltage of said respective fuel cell unit so as to collect said voltage of said fuel cell units;
(c) diagnosing said voltages of said fuel cell units, wherein when said voltage of said respective fuel cell unit is within a safety range, another two neighboring monitoring sensors are continuously switched on for reading said voltage of said subsequent fuel cell unit until said voltage of said last fuel cell unit is read; and
(d) generating an alert signal for indicating an abnormal operation of said respective fuel cell unit of said fuel cell stack when said voltage of said respective fuel cell unit is out of said safety range.

14. The method as recited in claim 13, after step (b), further comprising a step of converting said voltage of said fuel cell units into digital forms.

15. The method as recited in claim 13, in step (b), wherein said preceding monitoring sensor is automatically switched off when said subsequent monitoring sensor is switched on such that only said two neighboring monitoring sensors are switched on at said same time for reading said voltage of said respective fuel cell unit.

16. The method as recited in claim 14, in step (b), wherein said preceding monitoring sensor is automatically switched off when said subsequent monitoring sensor is switched on such that only said two neighboring monitoring sensors are switched on at said same time for reading said voltage of said respective fuel cell unit.

17. The method as recited in claim 13, in step (c), wherein when said voltage of said respective fuel cell unit is out of said safety range, said monitoring sensors are deactivated to stop reading said voltage of said next fuel cell unit so as to determine said abnormal operation of said fuel cell unit.

18. The method as recited in claim 16, in step (c), wherein when said voltage of said respective fuel cell unit is out of said safety range, said monitoring sensors are deactivated to stop reading said voltage of said next fuel cell unit so as to determine said abnormal operation of said fuel cell unit.

19. The method as recited in claim 13, in step (c), wherein when said voltage of said respective fuel cell unit is out of said safety range, said monitoring sensors keeps reading said voltage output of said next fuel cell unit until all said voltage of said fuel cell unit are read, wherein said alert signal indicates said abnormal operation of said respective fuel cell unit.

20. The method as recited in claim 16, in step (c), wherein when said voltage of said respective fuel cell unit is out of said safety range, said monitoring sensors keeps reading said voltage output of said next fuel cell unit until all said voltage of said fuel cell unit are read, wherein said alert signal indicates said abnormal operation of said respective fuel cell unit.
